(19) United States
(12) Patent Application Publication
(10) Pub. No.: US 2025/0321672 A1
(43) Pub. Date: Oct. 16, 2025

(54) METHODS AND SYSTEMS FOR TOUCHSCREEN DEVICE INTERACTIONS USING A VIRTUAL JOYSTICK

(71) Applicants: Roya CODY, Markham (CA); Wei ZHOU, Markham (CA); Horace LYNN, Markham (CA)

(72) Inventors: Roya CODY, Markham (CA); Wei ZHOU, Markham (CA); Horace LYNN, Markham (CA)

(21) Appl. No.: 18/634,253

(22) Filed: Apr. 12, 2024

(51) Int. Cl. G06F 3/04883; G06F 3/0484

(52) U.S. Cl. CPC G06F 3/04883; G06F 3/0484

(57) ABSTRACT

There are provided methods and devices for enabling touchscreen device interactions using a virtual joystick. In response to detecting a touch input detected at or near a display of the touchscreen device, touch contact information including a centroid and a contact shape of the touch input may be generated. A speed and a direction associated with an interactive element on the display may be determined, by a model, based on the touch contact information. The interactive element may be controlled on the display, based on the speed and the direction. The disclosed methods and devices may enable improved user interaction with touchscreen devices having limited interaction space, for example, by more accurately distinguishing small-scale micromovements as touch inputs.

### FIELD

The present disclosure relates to the field of human-computer interaction, in particular, for interacting with touch sensitive surfaces, and more specifically, to methods and systems for touchscreen device interactions using a virtual joystick.

### BACKGROUND

A physical keyboard, a physical mouse and a physical joystick are well-established components for interacting with computing devices such as smartphones, tablets, laptop computers, desktop computers, gaming consoles, etc. While effective, the physical keyboard, mouse, or joystick and their associated computer accessories (e.g. cables, etc.) can both limit the portability of a computing device and provide points of failure to the operation of the computing device. To address challenges around portability, a keyboard-embedded pointing stick or an integrated trackpad device provides for an alternative means of controlling a cursor on a computing device, such as a laptop computer or a smartphone etc. However, keyboard-embedded pointing sticks or integrated trackpad devices can be difficult to manipulate and still represent physical points of failure.

More recently, the touchscreen display has emerged as a desirable means for interacting with computing devices, with touchscreen displays commonly being incorporated into an increasing number of computing devices (e.g., smart phones, tablets, smart watches etc.). For example, touch gestures are commonly performed by a user to interact with the touchscreen device (e.g., by contacting a touch sensitive surface of the touchscreen display via a user's finger or by manipulating an external pointing device such as a stylus). In some examples, the touchscreen display may operate to provide a virtual keyboard, a virtual mouse or a virtual trackpad, thereby eliminating the requirement for a physical keyboard, mouse or trackpad when using an associated computing device. Many computing devices are becoming smaller and more compact, thereby imposing physical limitations on available interaction space associated with a touchscreen. As such, interacting with touchscreen devices, especially those with a smaller screen space can be cumbersome.

Accordingly, improvements in user interaction with touch screen devices are desired.

### SUMMARY

In various examples, the present disclosure describes methods and systems for improved user interactions with touchscreen devices using a virtual joystick. In response to receiving a touch input (e.g., touch input detected at or near a display of the touchscreen device), touch contact information including a centroid and a contact shape of the touch input may be generated. A speed and a direction associated with an interactive element on the display may be determined, by a model, based on the touch contact information. The interactive element may be controlled on the display, based on the speed and the direction. Examples of the disclosed methods and systems may enable improved user interaction with a touchscreen device having limited interaction space, for example, by leveraging small-scale micromovements for smoother user interactions.

In various examples, the present disclosure provides the technical effect that a virtual joystick is implemented on a touchscreen devices, for controlling interactive elements responsive to small-scale micromovement touch inputs. For example, as touchscreen devices become smaller, limited interaction space can make interacting with these devices more difficult. In this regard, improved user interaction using touch inputs that can be effectively implemented over a reduced screen area are beneficial.

In examples, the virtual joystick may provide advantages for quick cursor control on touchscreen devices, among other interactions, based on an improved touch input. For example, the touch contact information of the present disclosure may represent not only a centroid of the touch input (or a displacement of the centroid), but also a contact shape of the touch input. Recent advances in capacitive data processing, for example, using high-resolution models for processing raw capacitive data, may provide more precise estimates of the shape of touch inputs on touchscreen devices. In this regard, the present disclosure may provide for refined control of user interface elements using small-scale micromovements that were previously too small to be accurately distinguished.

In examples, the virtual joystick may also provide advantages for coupling with a virtual keyboard on the touchscreen device to facilitate keyboard and trackpad interaction without requiring explicit mode switching. Further, the virtual joystick may be coupled with voice input operations on the touchscreen device, for example, for seamless editing of dictated text within a text editing application.

In examples, the user-adaptive virtual keyboard may also provide advantages for smoother cursor interaction when a user's finger (or other touch input facilitator) is lifted from the touchscreen device. Some existing technologies may suffer from challenges in detecting a lifting gesture, for example, based on the change in raw capacitive signal detected as the finger is lifted from the touch-sensitive surface and causing a jitter in a cursor control or a jump in the cursor position on the display. Examples of the present disclosure may enable improvements in cursor movement by recognizing touch-lifting gestures.

In an example aspect, the present disclosure describes a computer-implemented method at an electronic device including: receiving a touch input detected at or near a display of the electronic device; generating touch contact information including a centroid and a contact shape of the touch input; determining, by a model, a speed and a direction associated with an interactive element on the display, based on the touch contact information; and controlling the interactive element on the display, based on the speed and the direction.

In an example of the preceding example aspect of the method, wherein the touch input corresponds to contact with the display.

In an example of a preceding example aspect of the method, wherein the touch input corresponds to input by a finger of a user in contact with the display.

In an example of the preceding example aspect of the method, the method further comprises: prior to receiving the touch input: activating a virtual joystick on the display of the electronic device, wherein a user interface (UI) controller of the electronic device is configured to control the interactive element in response to a user interaction with the virtual joystick.

In an example of a preceding example aspect of the method, wherein the user interaction with the virtual joystick corresponds to a micromovement of the user's finger in contact with the display, the micromovement comprising at least one of: a rolling movement; a rocking movement; or a pivoting movement.

In an example of a preceding example aspect of the method, wherein generating the touch contact information comprises: receiving a raw capacitive signal associated with the touch input; generating a high-resolution contact image based on the raw capacitive signal; and determining the contact shape and the centroid based on the high-resolution contact image.

In an example of a preceding example aspect of the method, wherein the touch input is a first touch input corresponding to an anchor position on the display, the method further comprising: receiving a sequence of further touch inputs; generating further touch contact information including at least one further contact shape or at least one further centroid, based on the sequence of further touch inputs; comparing at least one of the centroid of the first touch input with the at least one further centroid or the contact shape of the first touch input with the at least one further contact shape, to determine a displacement from the anchor position, based on the comparison; determining, by the model, an updated speed and an updated direction associated with the interactive element on the display, based on the displacement; and controlling the interactive element on the display, based on the updated speed and the updated direction.

In an example of a preceding example aspect of the method, wherein controlling the interactive element on the display comprises: providing the speed and the direction to a user interface (UI) controller of the electronic device for controlling the interactive element on the display.

In an example of a preceding example aspect of the method, wherein the interactive element is a cursor.

In an example of a preceding example aspect of the method, wherein the interactive element is a menu.

In an example of a preceding example aspect of the method, wherein the display is a capacitive touch-sensitive display.

In some example aspects, the present disclosure describes a touch-enabled device including: a touch-sensitive display, a processor coupled to the touch-sensitive display and a non-transitory memory coupled to the processor, the non-transitory memory storing machine-executable instructions which, when executed by the processor, cause the touch-enabled device to: receive a touch input detected at or near the display; generate touch contact information including a centroid and a contact shape of the touch input; determine, by a model, a speed and a direction associated with an interactive element on the display, based on the touch contact information; and control the interactive element on the display, based on the speed and the direction.

In an example of the preceding example aspect of the device, wherein the touch input corresponds to contact with the display.

In an example of a preceding example aspect of the device, wherein the touch input corresponds to input by a finger of a user in contact with the display.

In an example of the preceding example aspect of the device, wherein the instructions, when executed by the processor, cause the touch-enabled device to: prior to receiving the touch input: activate a virtual joystick on the display of the electronic device, wherein a user interface (UI) controller of the electronic device is configured to control the interactive element in response to a user interaction with the virtual joystick.

In an example of a preceding example aspect of the device, wherein the user interaction with the virtual joystick corresponds to a micromovement of the user's finger in contact with the display, the micromovement comprising at least one of: a rolling movement; a rocking movement; or a pivoting movement.

In an example of a preceding example aspect of the device, wherein the instructions, when executed by the processor to generate the touch contact information, cause the touch-enabled device to: receive a raw capacitive signal associated with the touch input; generate a high-resolution contact image based on the raw capacitive signal; and determine the contact shape and the centroid based on the high-resolution contact image.

In an example of a preceding example aspect of the device, wherein the touch input is a first touch input corresponding to an anchor position on the display, wherein the instructions, when executed by the processor, further cause the touch-enabled device to: receive a sequence of further touch inputs; generate further touch contact information including at least one further contact shape or at least one further centroid, based on the sequence of further touch inputs; compare at least one of the centroid of the first touch input with the at least one further centroid or the contact shape of the first touch input with the at least one further contact shape, to determine a displacement from the anchor position, based on the comparison; determine, by the model, an updated speed and an updated direction associated with the interactive element on the display, based on the displacement; and control the interactive element on the display, based on the updated speed and the updated direction.

In an example of a preceding example aspect of the device, wherein the instructions, when executed by the processor to control the interactive element on the display, further cause the touch-enabled device to: provide the speed and the direction to a user interface (UI) controller of the electronic device for controlling the interactive element on the display.

In an example of a preceding example aspect of the device, wherein the interactive element is a cursor.

In an example of a preceding example aspect of the device, wherein the interactive element is a menu.

In an example of a preceding example aspect of the device, wherein the display is a capacitive touch-sensitive display.

In some example aspects, the present disclosure describes a non-transitory computer-readable medium having machine-executable instructions stored thereon, the machine-executable instructions, when executed by a processor of a device having a touch-sensitive display, cause the device to: receive a touch input detected at or near the display; generate touch contact information including a centroid and a contact shape of the touch input; determine, by a model, a speed and a direction associated with an interactive element on the display, based on the touch contact information; and control the interactive element on the display, based on the speed and the direction.

In some example aspects, the present disclosure describes a non-transitory computer readable medium storing instructions thereon. The instructions, when executed by a processor, cause the processor to perform any of the preceding example aspects of the method.

### BRIEF DESCRIPTION OF THE DRAWINGS

Reference will now be made, by way of example, to the accompanying drawings which show example embodiments of the present application, and in which:

FIG. 1A is a block diagram illustrating an example electronic device which may be used to implement examples of the present disclosure;

FIG. 1B is a front view of an example embodiment of the electronic device 100;

FIG. 2 shows a block diagram of an example architecture for the virtual joystick module 200, in accordance with examples of the present disclosure;

FIGS. 3A-3B illustrate an example embodiment in which a touch-sensitive display of the electronic device receives a touch input;

FIGS. 4A-4D illustrate an example embodiment in which a touch-sensitive display of the electronic device receives a touch input as part of a sequence of touch inputs;

FIGS. 5A-5D illustrate an example embodiment in which a touch-sensitive display of the electronic device receives a touch input as part of a sequence of touch inputs;

FIG. 6 is a front view of an example embodiment of the electronic device;

FIG. 7 is a front view of an example embodiment of the electronic device;

FIGS. 8A-8D are a front view of an example embodiment of the electronic device; and

FIG. 9 is a flowchart illustrating an example method for enabling touchscreen device interactions using a virtual joystick, in accordance with examples of the present disclosure.

Similar reference numerals may have been used in different figures to denote similar components.

### DETAILED DESCRIPTION

In various examples, the present disclosure describes methods and devices that enable micromovement touch inputs to be used for interacting with an electronic device. Embodiments described herein allow a user to quickly engage with a virtual pointing device (e.g., a virtual joystick), for example, for improved cursor control in a space-efficient, intuitive, user-friendly manner.

In some implementations, systems and methods described herein provide for the use of touch micromovements and/or micro-gestures to activate and/or interact with a virtual joystick that mimics the operation of a physical joystick. The virtual joystick may operate contemporaneously with other virtual input devices, such as a virtual keyboard or a virtual mouse.

In the present disclosure, a “joystick” can mean: a pointing device for controlling a virtual object (such as a cursor) on a display of an electronic device, where the virtual object is controlled by maneuvering a lever of the joystick to rotate within a full range of motion of 360 degrees of rotation.

In the present disclosure, a “micromovement” or a “micro-gesture” can mean: a small scale or fine-grain movement of a user's finger (or other touch input facilitator) on a touchscreen that is characterized by a minimal displacement of the user's finger along the surface of the touchscreen, in contrast to broader touch gestures exhibiting large displacements of the user's finger along the touchscreen surface, such as swipe gestures. Examples include a rolling movement (also referred to as a “finger-roll” in examples where the touch input is provided by a user's finger), a rocking movement (also referred to as a “finger-rock” in examples where the touch input is provided by a user's finger), a pivoting movement (also referred to as a “finger pivot” in examples where the touch input is provided by a user's finger), etc. In general, it should be understood that although the present disclosure refers to a user's finger in contact with a touchscreen as the touch input, this disclosure is not limited to finger-based touch input. For example, a stylus or other conductive pointing device may be used as a touch input facilitator instead of the user's finger, in which case references to a “finger-roll”, a “finger-rock”, a “finger pivot”, etc. should be understood to encompass a “stylus-roll”, a “stylus-rock”, a “stylus pivot” and so forth. Additionally, it should be understood that description referring to contact with the touchscreen surface may encompass touch input that is detected when the touch input facilitator is in close proximity to the touchscreen surface without being strictly in contact. For example, a capacitive touchscreen may detect touch input without requiring physical direct contact with the touch input facilitator (e.g., the touch input facilitator may only need to be close enough to be detected by capacitive sensors).

In the present disclosure, a “finger pitch” can mean: the angle between the finger (or other touch input facilitator) and the touchscreen, for example, as the finger is engaged in a forward and/or backward rocking micro-gesture.

In the present disclosure, a “finger roll” can mean: a rotation of the finger (or other touch input facilitator) about an axis of the finger, for example, in a clockwise or counter-clockwise direction (e.g., right or left direction) when a finger is in contact with a touchscreen.

In the present disclosure, a “touchscreen device” can mean: an electronic device including a touchscreen element, such as a touch sensitive surface for sensing touch thereupon and receiving touch input and a display for providing output. In an embodiment, for example, a touchscreen may implement one or more touchscreen technologies, for example, the touchscreen device may be a capacitive touchscreen. In examples, a touchscreen device may be a smartphone, a tablet, a laptop, and/or other similar electronic device. In examples, the touchscreen device may be a type of computer system within the scope of the present disclosure.

In the present disclosure, an “electronic device” may be any device that has a touch sensitive display, including a mobile communication device (e.g., smartphone), a tablet device, a laptop device, a desktop device, a vehicle-based device (e.g., an infotainment system or an interactive dashboard device), a wearable device (e.g., smartwatch), an interactive kiosk device, or an Internet of Things (IoT) device, among other possibilities.

Other terms used in the present disclosure may be introduced and defined in the following description.

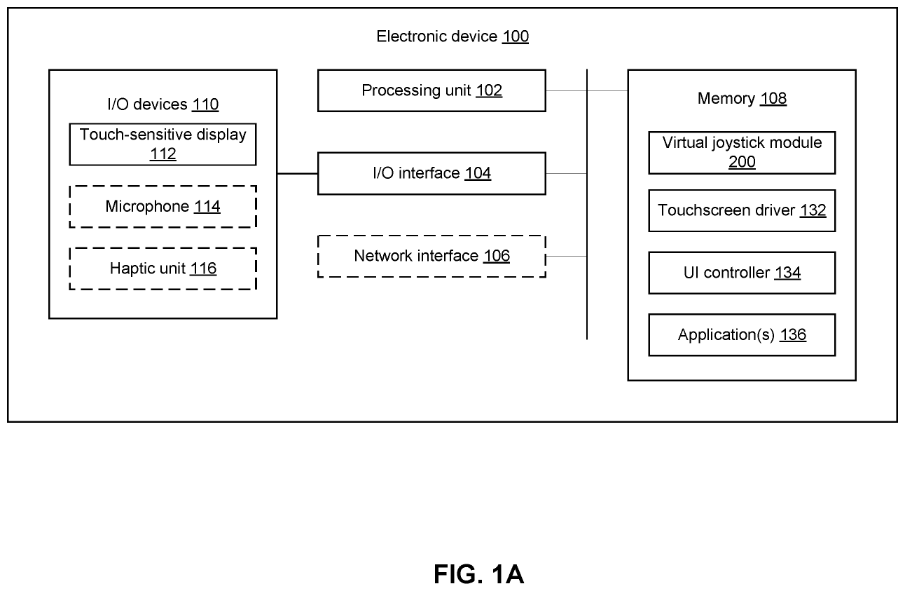

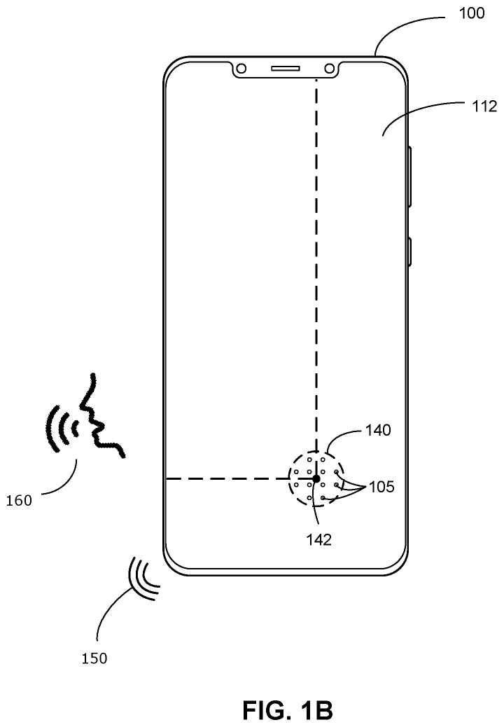

FIG. 1A is a block diagram showing some components of an example electronic device 100 (which may also be referred to generally as an apparatus), which may be used to implement embodiments of the present disclosure. Although an example embodiment of the electronic device 100 is shown and discussed below, other embodiments may be used to implement examples disclosed herein, which may include components different from those shown. Although FIG. 1A shows a single instance of each component, there may be multiple instances of each component shown.

The electronic device 100 includes one or more processing units 102, which may be a hardware processor such as a microprocessor, an application-specific integrated circuit (ASIC), a field-programmable gate array (FPGA), a dedicated logic circuitry, a dedicated artificial intelligence processor unit, or combinations thereof. The electronic device 100 also includes one or more input/output (I/O) interfaces 104, which interfaces with one or more I/O devices 110 such as a touch-sensitive display 112 (also referred to as a touchscreen or simply a display), optional microphone 114, and/or optional haptic unit 116 (also referred to as a vibration unit). The electronic device 100 may include other input devices (e.g., camera, physical buttons, keyboard, pressure sensor, etc.) and/or other output devices (e.g., speaker, lights, etc.).

The electronic device 100 may include one or more optional network interfaces 106 for wired or wireless communication with a network (e.g., an intranet, the Internet, a P2P network, a WAN and/or a LAN) or other node. The network interface 106 may include wired links (e.g., Ethernet cable) and/or wireless links (e.g., one or more antennas) for intra-network and/or inter-network communications. In some examples, the network interface 106 may enable the electronic device 100 to communicate with a network to access cloud-based services.

The electronic device 100 includes one or more memories 108, which may include a volatile or non-volatile memory (e.g., a flash memory, a random access memory (RAM), and/or a read-only memory (ROM)). The non-transitory memory 108 may store instructions for execution by the processing unit 102, such as to carry out examples described in the present disclosure. For example, the memory 108 may include instructions, executable by the processing unit 102, to implement a virtual joystick module 200 that receives a touch input 140 and generates parameters for controlling a virtual object (such as a cursor) via a user interface (UI), based on the touch input 140. The memory 108 may also include instructions to implement a touchscreen driver 132 that couples with the touch-sensitive display 112 for sensing the touch input 140 and/or for rendering content on the touch-sensitive display 112. The memory 108 may also include instructions to implement a UI controller 134 that controls interactions with the UI based on the touch input 140, as discussed further below. The memory 108 may also include instructions to implement one or more software applications 136 (e.g., email application, browser application, calendar application, text editor application etc.). The memory 108 may include other software instructions, such as for implementing an operating system and other functions of the electronic device 100.

In some examples, the electronic device 100 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the electronic device 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the electronic device 100 may communicate with each other via a bus, for example.

Examples of the present disclosure enable user interactions with the electronic device 100 using a touch input 140 (e.g., detected via the touch-sensitive display 112). Other variations may be encompassed by the present disclosure.

FIG. 1B is a front view of an example embodiment of the electronic device 100, which is a smartphone in this example. It should be understood that the description of FIG. 1B may be adapted for other embodiments of the electronic device 100, such as a tablet, laptop, smartwatch, etc.

A touch input 140 may be detected by the touch-sensitive display 112, for example, the touch input 140 may activate a 2D capacitive touch sensor embedded within the touch-sensitive display 112. A capacitive touch screen draws small electrical charges to a point of contact by a user, and functions as a capacitor in the region of contact. In some examples, in response to a touch input facilitator placed in contact with the touch-sensitive display 112, a change in the capacitance and electrostatic field in the capacitive panel of the touch-sensitive display 112 provides information (e.g., a corresponding raw capacitive signal that is representative of the touch input facilitator in contact with the touch-sensitive display 112). In examples, the raw capacitive signal may be used to determine location information or other touch contact information corresponding to a touch interaction with the touch-sensitive display 112. In some embodiments, for example, the touch input 140 may represent a micromovement or a micro-gesture, where the touch input 140 is associated with a sequence of touch inputs corresponding to fine-grained movements of a touch input facilitator on the touch-sensitive surface 112 (e.g., a rolling movement, a rocking movement, a pivoting movement or any combination thereof, among other small-scale and/or subtle movements of the touch input facilitator in contact with the touch-sensitive surface 112).

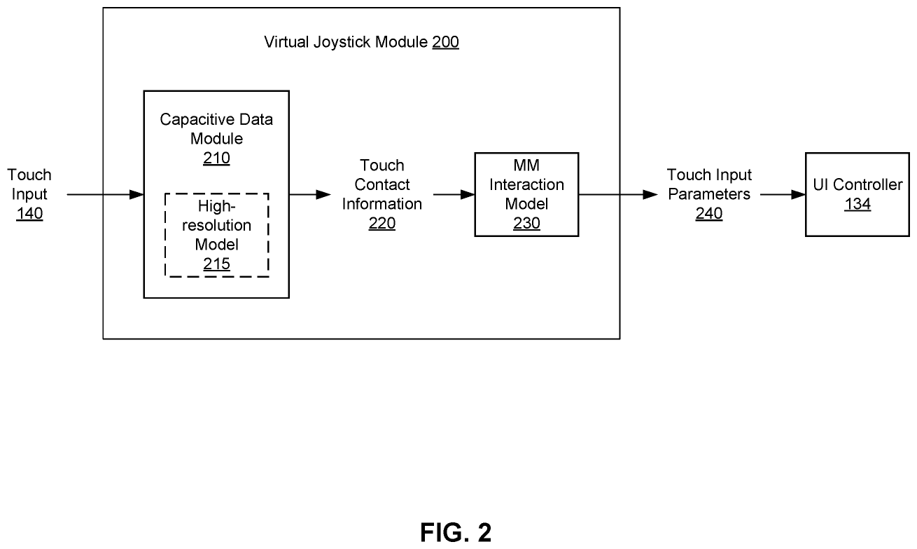

In examples, a plurality of capacitive sensor elements 105 of the touch-sensitive display 112 are shown arranged in a grid in proximity to the touch input 140. In examples, each capacitive sensor element 105 may measure a raw capacitive value associated with the touch input 140, where the collection of raw capacitive values represents a raw capacitive signal associated with the touch input 140. In examples, the raw capacitive signal may be processed to determine a location of the touch input 140, (also referred to as the touch location), where the location may be represented as an x-y coordinate in the frame of reference of the touch-sensitive display 112 (e.g., x-y coordinate in terms of screen pixels). In examples, the touch input 140 may be detected over a region of the touch-sensitive display 112 rather than at a point, in which case the touch location may be the centroid 142 of the touch input 140. While the touch input 140 is shown in FIG. 2 shaped as a circle for simplicity, it is understood that the touch input 140 may be detected over a region representing other shapes, such as an ellipse, or representing an irregular shape, among other shapes. In examples, the shape of the touch input 140 is dependent on the surface area of the touch input facilitator that is in contact with the touch-sensitive display 112, and optionally, the intensity of the contact (e.g., the force or pressure with which the touch input 140 is exerted on the touch-sensitive display 112). In examples where the touch input facilitator is a user's finger or thumb, where the mechanics of contact with the touch-sensitive display 112 are such that the pulp or pad of the fingertip may deform or compress on the surface of the touch-sensitive display 112 in response to transmitting a contact force from the user's finger, the intensity of the contact may influence the resulting size of the region that is detected for the touch input 140, for example, associated with the surface area of the finger or thumb that is in contact with the touch-sensitive display 112. For example, a touch input 140 having a high intensity may be associated with the detection over a larger region than a touch input 140 having a low intensity. While examples of contact intensity are described in the context of a finger or thumb in contact with the touch-sensitive display 112, it is understood that any touch input facilitator representative of a material that is compressible or deformable upon contact with the touch-sensitive display 112 may be influenced by the intensity of the contact). In examples, the location of the touch input 140, (e.g., represented by respective x-y coordinates), along with other parameters of the touch input 140, may be provided as sensed inputs and used by the UI controller 134 to manage interactions with a UI displayed on the touch-sensitive display 112.

In some embodiments, for example, the UI controller 134 may also communicate with an optional haptic unit 116 to generate a haptic feedback 150 associated with the user interactions. In some embodiments, for example, the user interaction may be a multimodal interaction, including a touch input 140 and a speech signal 160, for interacting with a virtual object in the GUI.

To assist in understanding the present disclosure, some background about touch-based interactions on touchscreens is provided.

Common touch-based interactions rely on the detection of touch gestures, for example, a tap gesture, a swipe gesture, a pinch gesture, a dwell or tap-and-hold gesture, among others. In examples, a touch gesture may be initiated when contact (e.g., by a finger 10 of a user's hand, by a stylus, or by any other touch input facilitator) is first detected by a touch-sensitive display 112 and the touch gesture may end upon removing contact with the touch-sensitive display 112 (e.g., when the finger 10 is lifted from the surface the touch-sensitive display 112), among other possibilities. In some examples, a touch gesture may involve contacting the touch-sensitive display 112 with one finger 10 or more than one finger 10 of the user's hand and/or moving the one or more fingers 10 over the surface of the touch-sensitive display 112 along a path over a period of time. In examples, a touch gesture may therefore be associated with a plurality of touch locations defining one or more paths along the touch-sensitive display 112, for example, where each path is provided as a 2D vector of touch locations.

Touch gestures associated with existing virtual controllers often incorporate touch input from multiple fingers of a user's hand. An example virtual mouse controller is described in: Au, O. K. C., & Tai, C. L. (2010), “Real-time finger registration for enriching multi-touch interfaces: with virtual mouse application”, Computer Science Technical Report; HKUST-CS10-02, the entirety of which is hereby incorporated by reference. The virtual mouse controller described in Au and Tai (2010) relies on touch contact by multiple fingers on a touch-sensitive surface for emulating a mouse, where the thumb controls the cursor movement and the index and middle finger control the left and right click. Another example virtual controller is described in: Matejka, J., Grossman, T., Lo, J., & Fitzmaurice, G. (2009, April), “The design and evaluation of multi-finger mouse emulation techniques”, Proceedings of the SIGCHI conference on Human factors in computing systems (pp. 1073-1082), the entirety of which is hereby incorporated by reference. Similarly, the virtual controller of Matejka et al., (2009) represents a virtual mouse requiring multi-finger touchscreen contact for performing the same tasks as a traditional mouse. Another example virtual controller is described in: Micire, M., et al., “Design and validation of two-handed multi-touch tabletop controllers for robot teleoperation”, Proceedings of the 16th international conference on Intelligent user interfaces, 2011, the entirety of which is hereby incorporated by reference. The virtual controller of Micire et al., (2011) represents a virtual gaming controller providing for 2-DoF control using a user's thumb in contact with a touchscreen device to effect control in Left/Right and Up/Down directions, while other fingers of the user's hand are anchored to the screen. However, virtual controllers incorporating multi-finger touch configurations require considerable touchscreen space to accommodate contact with the multiple fingers and the corresponding range of thumb and/or finger movement. For example, devices having limited touchscreen interaction space (e.g., smart watches, etc.) may not be conducive to virtual controllers requiring multiple finger interactions.

Touch gestures associated with virtual controllers often require mode switching operations to enable the virtual controller, such as a virtual mouse or trackpad on touchscreen surfaces. Use of explicit mode switching gestures can be time consuming and cumbersome for displays with limited space. An example virtual controller is described in Kim, S., & Lee, G. (2016, May), “Tapboard 2: Simple and effective touchpad-like interaction on a multi-touch surface keyboard”, Proceedings of the 2016 CHI Conference on Human Factors in Computing Systems (pp. 5163-5168), the entirety of which is hereby incorporated by reference. The virtual controller of Kim and Lee (2016) proposes a unified virtual keyboard and touchpad incorporating a contact time and contact sequence-based methodology for control via separate touch interfaces. However, devices having limited touchscreen interaction space (e.g., smart watches, etc.) may not be conducive to virtual controllers involving mode switching steps or displaying virtual controllers that occlude a portion of the display, for example, by enabling a virtual trackpad.

Another example controller is described in: Parsoya, A., & Rajamanickam, V. (2019, November), “KeySlide: using directional gestures on keyboard for cursor positioning”, Proceedings of the 10th Indian Conference on Human-Computer Interaction (pp. 1-11), the entirety of which is hereby incorporated by reference. The virtual controller described in Parsoya (2019) involves the use of finger-sliding touch gestures over physical keyboards to reposition a text cursor in text editing applications. Alternatively, a physical pointing stick, for example, incorporated into a physical keyboard (e.g., the TrackPoint™ pointing stick etc.) may receive a shear force input from a user similarly to an in-situ joystick controller. In examples, a user may engage with a physical pointing stick for quick cursor control during typing interactions on a physical keyboard, due to the proximity of the pointing stick to the keyboard keys. However, fine cursor control with a pointing stick may be difficult, among other challenges. Further, such physical interactions may not be easily implemented within virtual controllers for interaction on touchscreen devices.

In the present disclosure, examples are described that may provide improvements over some of the existing touch-based interactions. Examples of the present disclosure may enable a user to interact with an electronic device using micromovement touch inputs via a virtual joystick, for example, for improved interaction on touchscreen devices having a limited screen size.

FIG. 2 shows a block diagram of an example architecture for the virtual joystick module 200, in accordance with examples of the present disclosure. The virtual joystick module 200 may be software that is implemented in the electronic device 100 of FIG. 1A, in which the processing unit 102 is configured to execute instructions of the virtual joystick module 200 stored in the memory 108. The virtual joystick module 200 in this example includes a capacitive data module 210 and a micromovement (MM) interaction model 230 and generates touch input parameters 240, for example, for inputting to a UI controller 134 of the electronic device 100.

In examples, a touch input 140 caused by one or more fingers 10 of a user's hand contacting the touch-sensitive display 112 may be received by the capacitive data module 210. In examples, the capacitive data module 210 may be configured to continuously monitor for touch inputs 140 and, in response to detecting a touch input 140 (or a sequence of touch inputs, for example, associated with a micromovement or a micro-gesture, among other touch gestures), may record and store raw capacitive data (e.g., raw capacitive signals) associated with the detected touch input 140.

In examples, the capacitive data module 210 may process the raw capacitive data to generate touch contact information 220. In some embodiments, for example, the capacitive data module 210 may interface with the touch-sensitive display 112 and/or the touchscreen driver 132 to generate touch contact information 220 including a touch location (e.g., an x-y coordinate), a shape of the touch input 140 (e.g., a region, a contact shape etc.) and/or a centroid 142 of the touch input 140, for example, using capacitive data processing methods associated with the electronic device 100. For example, processing the raw capacitive data to generate touch contact information 220 may include filtering the raw capacitive data, or processing the raw capacitive data using other methods, among other possibilities, and the touch contact information may be generated from the filtered (or processed) capacitive data. In other examples, touch contact information 220 may be generated from the raw capacitive data.

In examples, when a touch input 140 is associated with a sequence of touch inputs, a first touch input of the sequence of touch inputs may be identified, for example, corresponding to an anchor position of the user's finger 10 in contact with the touch-sensitive display 112. In examples, the capacitive data module 210 may process the raw capacitive data associated with the first touch input to generate touch contact information 220 associated with the first touch input along with touch contact information 220 for each subsequent touch input in the sequence of touch inputs. In examples, the touch contact information 220 may include an anchor position centroid associated with the first touch input, along with respective one or more centroids for each subsequent touch input in the sequence of touch inputs, among other information. In this regard, the capacitive data module 210 may further determine, for each centroid of the sequence of touch inputs, a respective displacement from the anchor position centroid.

In some embodiments, for example, the capacitive data module 210 may implement a high-resolution model 215 for generating one or more high-resolution contact images from the one or more raw capacitive signals associated with the touch input 140. An example high-resolution model 215 that can be implemented in example embodiments is described in: Streli, P., and Holz, C., “Capcontact: Super-resolution contact areas from capacitive touchscreens”, Proceedings of the 2021 CHI Conference on Human Factors in Computing Systems, 2021, the entirety of which is hereby incorporated by reference. In this regard, touch contact information 220 may be generated using the one or more high-resolution contact images associated with the touch input 140. In examples, leveraging the high-resolution model 215 may result in touch contact information 220 representing a more detailed and accurate outline of the shape of the touch input 140 on the touch-sensitive display 112, or representing a more accurate centroid of the touch input 140, compared to touch contact information 220 generated using a standard capacitive data processing method associated with conventional touchscreen devices (e.g., smartphones, smartwatches etc.).

In examples, the high-resolution model 215 may extrapolate a high-resolution contact area between the user's finger 10 and the touch-sensitive display 112, from the one or more raw capacitive signals associated with the touch input 140, to generate respective high-resolution contact images. In this regard, the touch contact information 220 may include a contact area, a centroid, a contact shape, and/or one or more shape parameters such as minor axis length, major axis length or aspect ratio, among other parameters associated with the touch input 140, for example, that may be determined from the high-resolution contact images. Similarly, when the touch input 140 is associated with a sequence of touch inputs, one or more high-resolution contact images associated with the first touch input of the sequence of touch inputs (e.g., one or more high-resolution anchor position contact images) and one or more high-resolution contact images associated with each subsequent touch input of the sequence of touch inputs may be generated. The capacitive data module 210 may generate touch contact information 220 including a contact area, a centroid, a contact shape, shape parameters etc. associated with the first touch input (e.g., anchor position) and each subsequent touch input of the sequence of touch inputs. In examples, the touch contact information 220 may further include a respective centroid displacement for each subsequent touch input of the sequence of touch inputs, compared to the anchor position centroid, as well as a respective change in contact area, change in contact shape, and/or change in shape parameters etc. for each subsequent touch input of the sequence of touch inputs, compared to the anchor position.

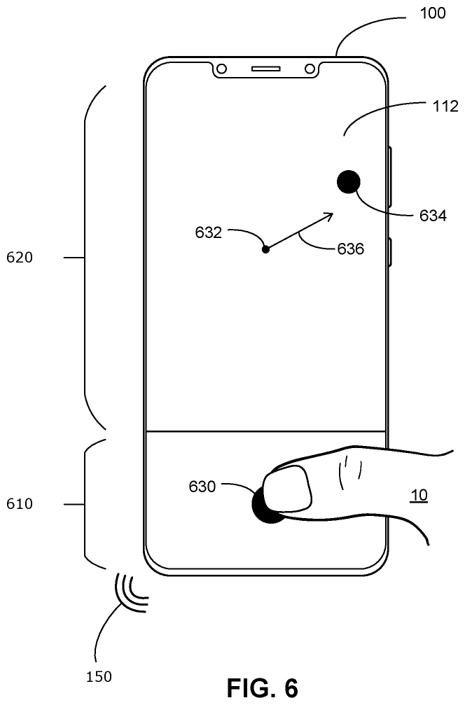

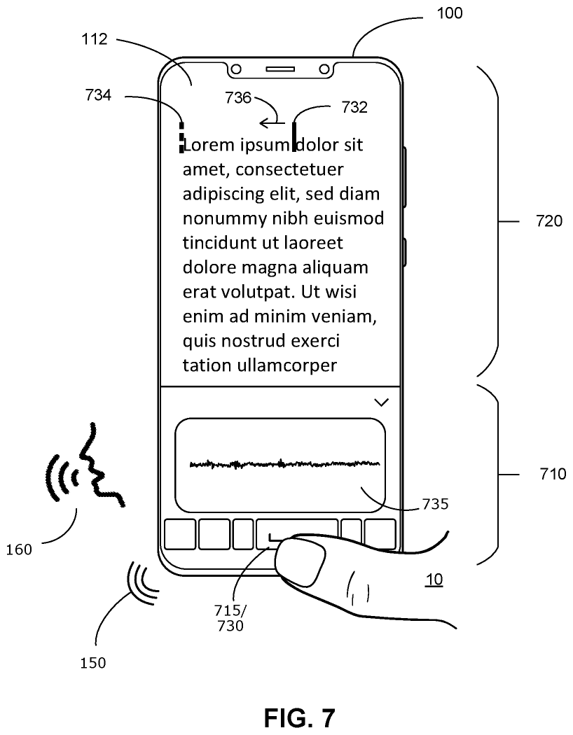

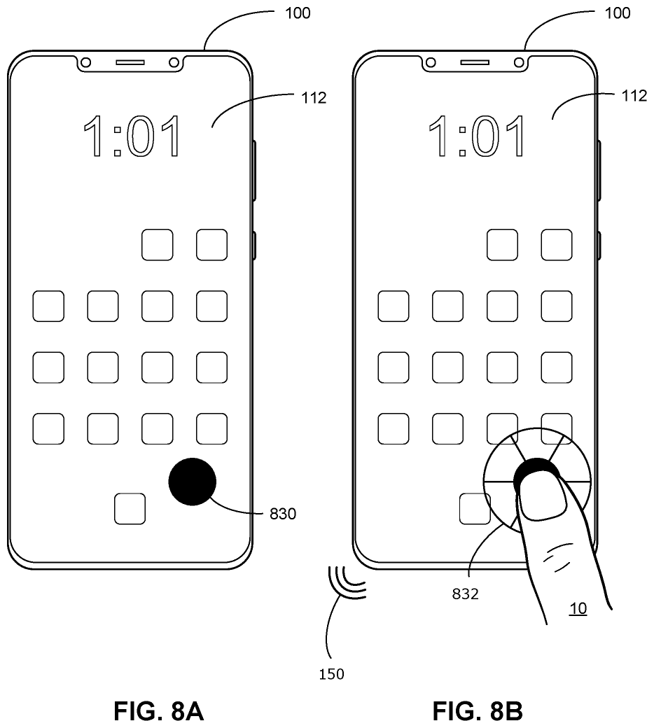

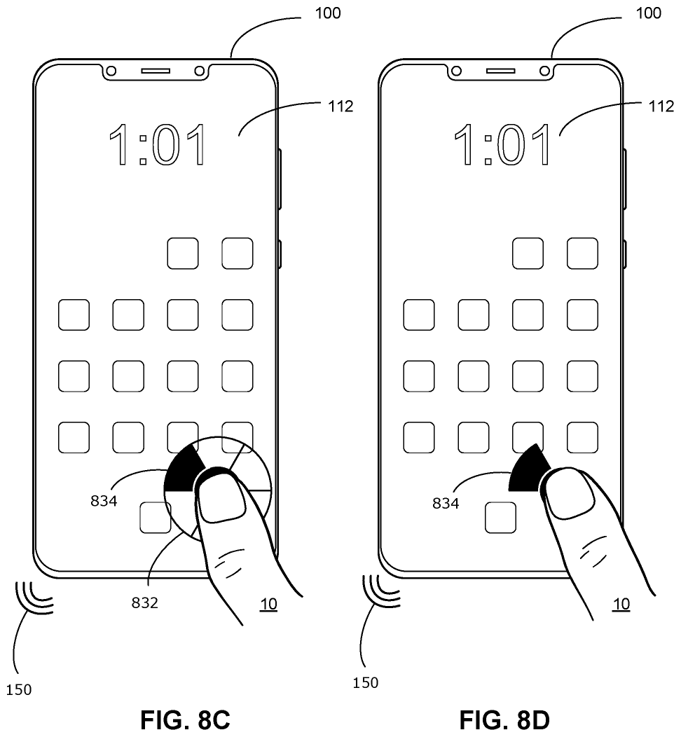

In examples, the micromovement (MM) interaction model 230 may receive the touch contact information 220 for generating touch input parameters 240 for managing interactions with a UI displayed on the touch-sensitive display 112. In examples, the MM interaction model 230 may be control-display (CD) gain model, for example, incorporating one or more functions (e.g., a gain function, among others) for defining a relationship between micro-movements applied to the touch-sensitive display 112 (e.g., represented by touch contact information 220) and movements of a virtual element on the display (e.g., represented by the touch input parameters 240). For example, the gain function may be a constant, where values of the touch contact information 220 are uniformly multiplied by a constant value to determine the touch input parameters 240, or the gain function may be non-uniform (e.g., linear, quadratic, sigmoid, exponential etc.). In examples, when the virtual joystick interaction is for interacting with a cursor on the touch-sensitive display 112, the touch input parameters 240 may represent cursor parameters, such as a speed of a cursor or a direction of a cursor (e.g., as described with respect to FIG. 6 and FIG. 7 below), among other cursor parameters. In this regard, the MM interaction model 230 may provide a mapping between the touch contact information 220 and a cursor speed and/or a cursor direction, for example, using the gain function. In other examples, the touch input parameters 240 may facilitate interacting with a menu on the touch-sensitive display 112, such as a radial or marking menu (e.g., as described with respect to FIGS. 8A-8D below), among other menus, or the touch parameters 240 may activate other applications or features on the electronic device 100. In other embodiments, for example, the MM interaction model 230 may be a trained machine learning (ML) model, or other models may be used.

In examples, the MM interaction model 230 may determine the touch input parameters 240 based on a dynamic sequence of touch inputs or based on a single touch input 140. In some embodiments, for example, the MM interaction model 230 may determine the touch input parameters 240 based on a change in centroid location from an anchor position centroid (e.g., measured as a displacement from the anchor position centroid 142 in any direction), over a sequence of touch inputs, for example, measured as a dynamic centroid displacement value. In other embodiments, for example, the MM interaction model 230 may determine the touch input parameters 240 based on a single contact shape (e.g., a static high-resolution contact image delineating a high-resolution contact shape for the touch input 140) and/or based on a change in the contact shape from an anchor position contact shape over a sequence of touch inputs. In this regard, leveraging a high-resolution capacitive data processing model (e.g., the high-resolution model 215) to generate the touch contact information 220 having a more detailed and accurate outline of the shape of the touch input 140 on the touch-sensitive display 112 may enable the virtual joystick module 200 to accurately control a virtual joystick in response to fine-grain micromovements applied to a touch-sensitive display 112. In other embodiments, for example the MM interaction model 230 may determine the touch input parameters 240 based on a combination of a dynamic centroid displacement and a contact shape, for example, a static contact shape or a dynamic change in contact shape over a sequence of touch inputs, among other possibilities. In some embodiments, for example, the MM interaction model 230 may be a trained ML model that has been trained to predict the touch input parameters 240 based on the one or more raw capacitive signals and/or the one or more high-resolution contact images of the touch contact information 220 associated with the touch input 140. In examples, the MM interaction model 230 may be trained using a training dataset including raw capacitive data (e.g., a set of raw capacitive signals) and/or a set of high-resolution contact images that have been labeled with target cursor directions and/or target cursor speeds. In other examples, the training dataset may include a set of raw capacitive signals and/or a set of high-resolution contact images that are labeled with gain functions or other functions of an equation, among other possibilities.

In some embodiments, for example, the MM interaction model 230 may also be a ML model that has been trained to recognize a lifting gesture, for example, when a user's finger 10 is lifted from the surface of the touch-sensitive surface 112. Some existing technologies may suffer from challenges in detecting a lifting gesture, for example, based on the change in raw capacitive signal detected as the finger is lifted from the touch-sensitive surface, thereby causing a jitter in a cursor control or a jump in the cursor position on the display, among other undesirable results. In examples, by training the MM interaction model 230 to recognize when a user's finger 10 is lifted, touch interactions on a touch-sensitive surface may be improved. For example, the MM interaction model 230 may reduce cursor jitter by selecting when a touch input 140 can be used for controlling cursor parameters and when it can be ignored (e.g., when the finger is being lifted). For example, as a user's finger is being lifted from a touch-sensitive surface, the size of the contact shape may rapidly decrease, and corresponding centroid information may be unreliable for controlling cursor parameters. In this regard, applying a threshold based on a trained ML model to determine when to a use touch input 140 for controlling cursor parameters, and when to ignore the touch input 140 may enable improved cursor control.

In examples, the touch input parameters 240 may be inputted to a UI controller 134 for controlling the virtual joystick in a UI of the electronic device 100. In examples, the UI controller may use the touch input parameters 240 to implement virtual joystick functionality within the UI. For example, the touch input parameters 240 may be used to control or determine joystick initiation, trigger mechanisms, cursor speed calculations, cursor directions or menu selections, among other interactions with applications 136 on the electronic device 100.

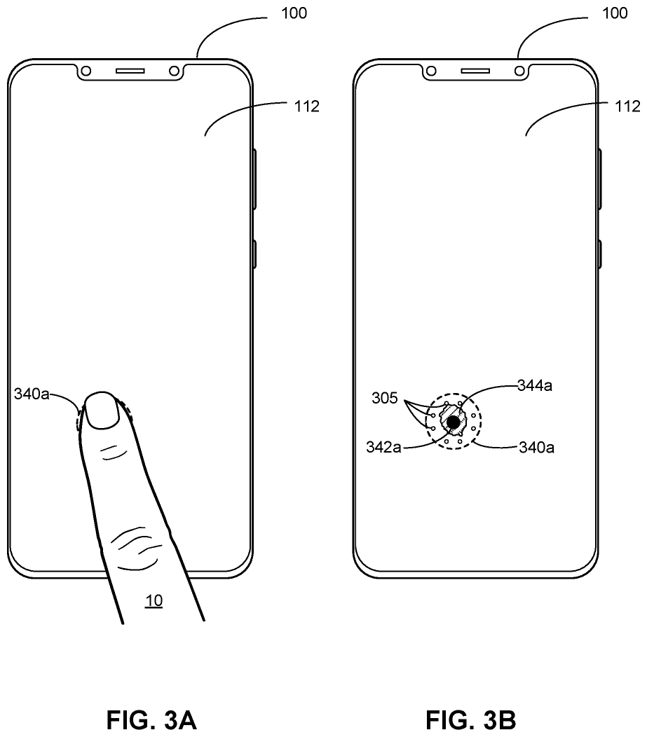

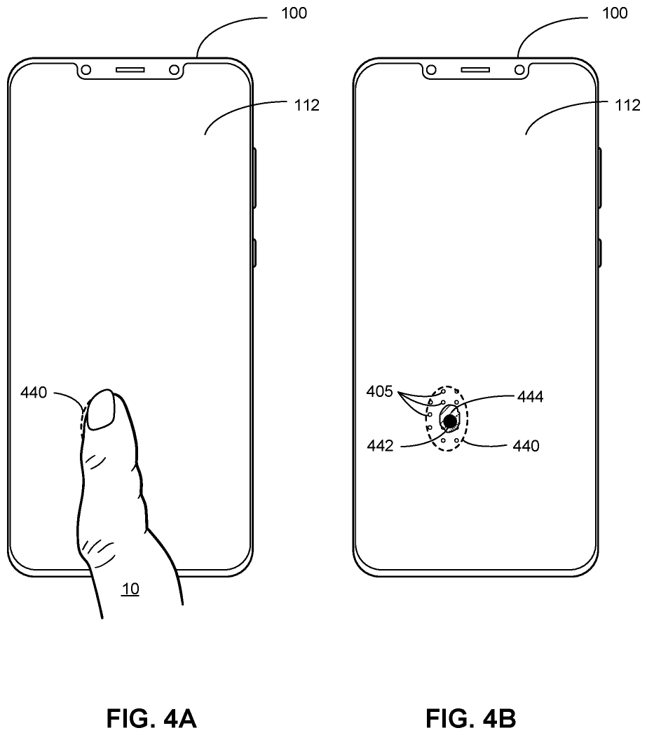

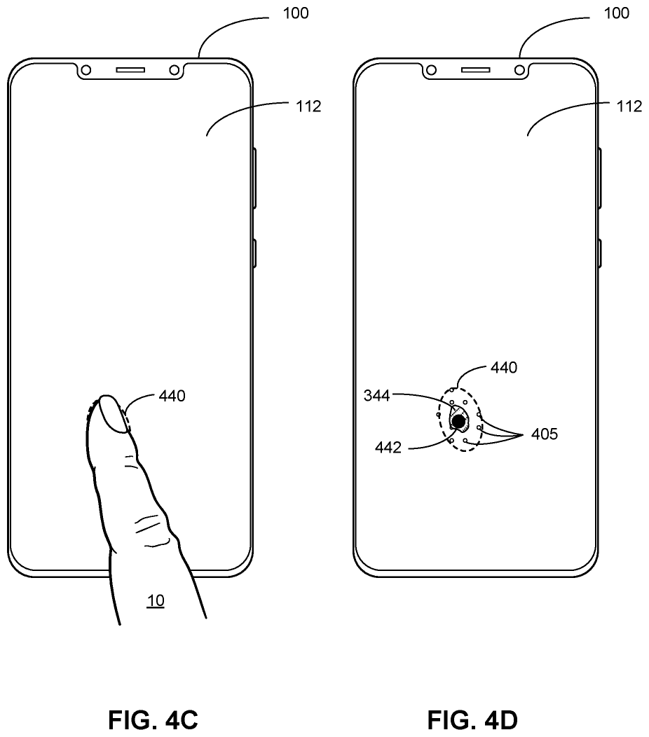

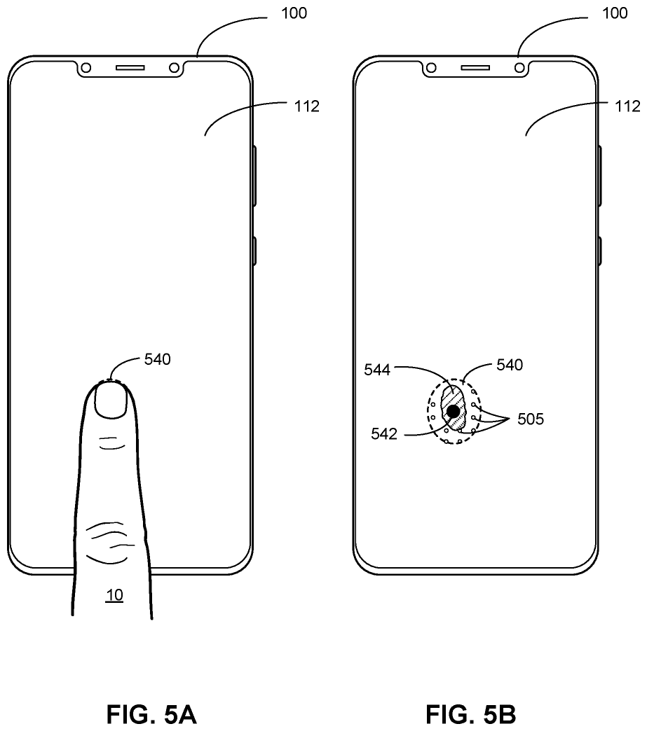

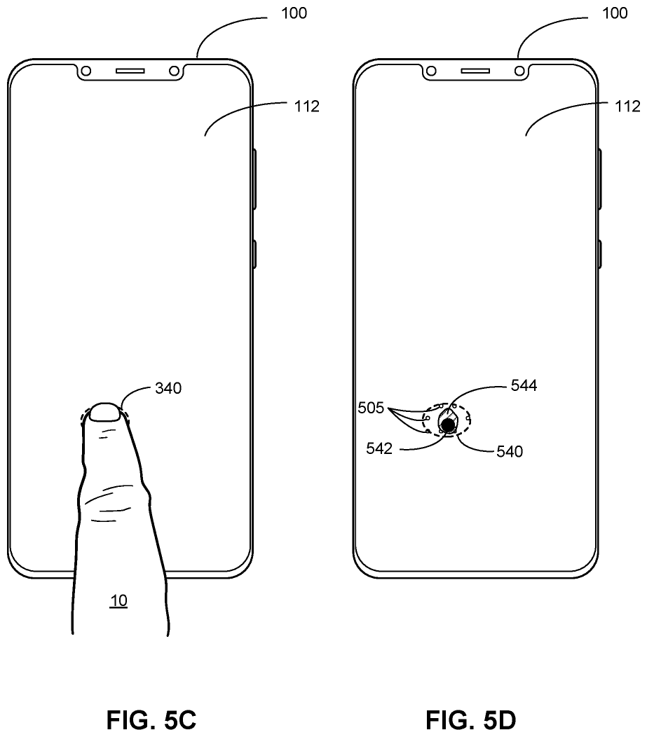

FIGS. 3A-3B illustrate an example embodiment in which a touch-sensitive display 112 of the electronic device 100 receives a touch input 140. In examples, the touch input 140 may be considered to be a first touch input 340a in a sequence of touch inputs (e.g., described with respect to FIGS. 4A-D and FIGS. 5A-D) and may therefore be recognized as an anchor position on the touch-sensitive display 112. Although FIGS. 3A-3B are illustrated in the context of a smartphone as the electronic device 100, this is not intended to be limiting. Similarly, although FIGS. 3A-3B are illustrated and discussed in the context of a finger 10 in contact with the touch-sensitive display 112 as the touch input 140, this is not intended to be limiting (e.g., other types of touch input facilitators, such as a stylus, may be used where similar rolling, rocking, and/or pivoting, etc. motions of the touch input facilitator, or any combination thereof, would cause detectable changes in the touch input 140).

In FIG. 3A, the first touch input 340a may be detected over a region of the touch-sensitive display 112, depicted for simplicity as a circle underneath the user's finger 10, and shown in FIG. 3B without the user's finger 10. In FIG. 3B, a plurality of capacitive sensor elements 305 of the touch-sensitive display 112 are shown arranged in a grid in proximity to the first touch input 340a. In examples, each capacitive sensor element 305 may measure a raw capacitive value associated with the corresponding first touch input 340a, where a distribution of raw capacitive values represents a raw capacitive signal associated with the first touch input 340a.

In examples, the raw capacitive signal associated with the first touch input 340a may be processed by a high-resolution model 215 to generate touch contact information 220, including a high-resolution contact image, from which a high-resolution contact shape (e.g., anchor shape 344a) and a centroid location (e.g., anchor centroid 342a), among other touch contact information 220, may be determined. In examples, by using the high-resolution model 215, the anchor shape 344a is shown as having a detailed outline of the touch contact. In this regard, changes in the contact shape or centroid (among other parameters) associated with subsequent touch inputs in a sequence of touch inputs, for example, caused by fine-grain micromovements of the user's finger may be more easily distinguished and provided as sensed inputs for use by the UI controller 134 to manage interactions with a UI displayed on the touch-sensitive display 112. For example, as shown in FIG. 3B, the anchor shape 344a may be irregular, for example, described as or resembling a “blob”, among other shapes. In examples, the touch contact information 220 may represent the anchor shape 344a in terms of a total area defined by a boundary. In other examples, the anchor shape 344a may be represented in terms of corresponding shape parameters, such as minor axis length, major axis length, aspect ratio etc.

FIGS. 4A-4D illustrate an example embodiment in which a touch-sensitive display 112 of the electronic device 100 receives a touch input 440 as part of a sequence of touch inputs. In examples, the sequence of touch inputs may represent a “finger roll” about an axis of rotation. In examples, the user's finger 10 is shown in FIG. 4A rolling to the left on the touch-sensitive surface 112 with respect to anchor position 340 (as described with respect to FIGS. 3A-3B) and the user's finger 10 is shown in FIG. 4C rolling to the right on the touch-sensitive surface 112 with respect to anchor position 340. Although FIGS. 4A-4D are illustrated in the context of a smartphone as the electronic device 100, this is not intended to be limiting. Similarly, although FIGS. 4A-4D are illustrated and discussed in the context of a finger 10 in contact with the touch-sensitive display 112 as the touch input 140, this is not intended to be limiting (e.g., other types of touch input facilitators, such as a stylus, may be used where similar rolling, rocking, and/or pivoting, etc. motions of the touch input facilitator, or any combination thereof, would cause detectable changes in the touch input 140).

In FIG. 4A, the touch input 440 may be detected over a region of the touch-sensitive display 112, depicted for simplicity as an ellipse underneath a side edge of the user's finger 10, and shown in FIG. 4B without the user's finger 10. In FIG. 4B, a plurality of capacitive sensor elements 405 of the touch-sensitive display 112 are shown arranged in a grid in proximity to the touch input 440. In examples, each capacitive sensor element 405 may measure a raw capacitive value associated with the corresponding touch input 440, where a distribution of raw capacitive values represents a raw capacitive signal associated with the touch input 440.

In examples, the raw capacitive signal associated with touch input 440 may be processed by a high-resolution model 215 to generate touch contact information 220, including a high-resolution contact image, from which a high-resolution contact shape (e.g., contact shape 444) and a centroid 442, among other touch contact information 220, may be determined. In examples, by using the high-resolution model 215, the contact shape 444 is shown as having a detailed outline of the touch contact. For example, compared to the anchor shape 344a of FIG. 3B, the contact shape 444 is smaller and slightly elongated, for example, representative of a smaller surface area of the edge of the user's finger 10 in contact with the touch-sensitive display 112 caused by the “finger-roll” micro-gesture. Further, a displacement and/or direction of displacement between the anchor centroid 342a and the centroid 442 may further inform a recognition by the virtual joystick module 200 of the “finger-roll” micro-gesture of the user's finger 10 in contact with the touch-sensitive display 112. In this regard, the combined use of a high-resolution contact shape 444 and a centroid 442, among other touch contact information 220, may enable improved touch interactions on a touch-sensitive surface.

Similarly, in FIG. 4C, the touch input 440 may be detected over a region of the touch-sensitive display 112, depicted for simplicity as an ellipse underneath a side edge of the user's finger 10, and shown in FIG. 4D without the user's finger 10. In FIG. 4D, a plurality of capacitive sensor elements 405 of the touch-sensitive display 112 are shown arranged in a grid in proximity to the touch input 440. In examples, each capacitive sensor element 405 may measure a raw capacitive value associated with the corresponding touch input 440, where a distribution of raw capacitive values represents the raw capacitive signal associated with the touch input 440.

FIGS. 5A-5D illustrate an example embodiment in which a touch-sensitive display 112 of the electronic device 100 receives a touch input 540 as part of a sequence of touch inputs. In examples, the sequence of touch inputs may represent micromovements involving changes in the pitch of the user's finger 10 (e.g., a “finger rock”). In examples, the user's finger 10 is shown in FIG. 5A flattening or “rocking down” on the touch-sensitive surface 112 with respect to anchor position 340 (as described with respect to FIGS. 3A-3B) and the user's finger 10 is shown in FIG. 5C pitching forward on to the tip of the finger 10 or “rocking up” on the touch-sensitive surface 112 with respect to anchor position 340. Although FIGS. 5A-5D are illustrated in the context of a smartphone as the electronic device 100, this is not intended to be limiting. Similarly, although FIGS. 5A-5D are illustrated and discussed in the context of a finger 10 in contact with the touch-sensitive display 112 as the touch input 140, this is not intended to be limiting (e.g., other types of touch input facilitators, such as a stylus, may be used where similar rolling, rocking, and/or pivoting, etc. motions of the touch input facilitator, or any combination thereof, would cause detectable changes in the touch input 140).

In FIG. 5A, the touch input 540 may be detected over a region of the touch-sensitive display 112, depicted for simplicity as an ellipse underneath a fingertip (e.g., a pad of the fingertip) of the user's finger 10, and shown in FIG. 5B without the user's finger 10. In FIG. 5B, a plurality of capacitive sensor elements 505 of the touch-sensitive display 112 are shown arranged in a grid in proximity to the touch input 540. In examples, each capacitive sensor element 505 may measure a raw capacitive value associated with the corresponding touch input 540, where a distribution of raw capacitive values represents the raw capacitive signal associated with the touch input 540.

In examples, the raw capacitive signal associated with touch input 540 may be processed by a high-resolution model 215 to generate touch contact information 220, including a high-resolution contact image, from which a high-resolution contact shape (e.g., a contact shape 544) and a centroid 542, among other touch contact information 220, may be determined. In examples, by using the high-resolution model 215, the contact shape 544 is shown as having a detailed outline of the touch contact. For example, compared to the anchor shape 344a of FIG. 3B, the contact shape 544 is larger and considerably elongated, consistent with the pressing down on a fingertip pad of a user's finger 10 on to the touch-sensitive display 112 and generating a larger surface area of the user's finger 10 in contact with the touch-sensitive display 112. Further, a displacement and/or direction of displacement between the anchor centroid 342a and the centroid 542 may further inform a recognition by the virtual joystick module 200 of the “finger-rock” micro-gesture of the user's finger 10 in contact with the touch-sensitive display 112. In this regard, the combined use of a high-resolution contact shape 544 and a centroid 542, among other touch contact information 220, may enable improved touch interactions on a touch-sensitive surface.

Similarly, in FIG. 5C, the touch input 540 may be detected over a region of the touch-sensitive display 112, depicted for simplicity as an ellipse underneath the top of the fingertip of the user's finger 10, and shown in FIG. 5D without the user's finger 10. In FIG. 5D, a plurality of capacitive sensor elements 505 of the touch-sensitive display 112 are shown arranged in a grid in proximity to the touch input 540. In examples, each capacitive sensor element 505 may measure a raw capacitive value associated with the corresponding touch input 540, where a distribution of raw capacitive values represents the raw capacitive signal associated with the touch input 540.

FIG. 6 is a front view of an example embodiment of the electronic device 100, which is a smartphone in this example. Although FIG. 6 is illustrated in the context of a smartphone as the electronic device 100, this is not intended to be limiting. It should be understood that the description of FIG. 6 may be adapted for other embodiments of the electronic device 100, such as a tablet, laptop, smartwatch, etc. Similarly, although FIG. 6 is illustrated and discussed in the context of a finger 10 in contact with the touch-sensitive display 112 as the touch input 140, this is not intended to be limiting (e.g., other types of touch input facilitators, such as a stylus, may be used where similar rolling, rocking, and/or pivoting, etc. motions of the touch input facilitator, or any combination thereof, would cause detectable changes in the touch input 140).

For exemplary purposes, the UI of the electronic device 100 in FIG. 6 is configured to include a control region 610, including a virtual joystick 630 rendered on the touch-sensitive display 112, and a main region 620, however it should be understood that other UI configurations may be used. In the example of FIG. 6, a cursor 632 is rendered in the main region 620. A finger 10 (or thumb) of a user's hand may interact with the cursor 632 using the virtual joystick 630, for example, a touch input or a sequence of touch inputs may be detected by the touch-sensitive display 112 in the control region 610. In examples, a user may position the finger 10 in proximity to the virtual joystick 630 and may engage in one or more micromovements on the touch-sensitive display 112 to cause the cursor 632 to move on the display.

In some embodiments, for example, the micromovement may be a pivot micromovement, or another micromovement may be performed. For example, a user desiring to move the cursor 632 toward a target position 634 on the touch-sensitive display 112 along a trajectory 636 (e.g., upwards and to the right) may first position the finger 10 on the touch-sensitive display 112 in proximity to the virtual joystick 630 and subsequently may pivot the finger 10 to apply a shear force to the touch-sensitive display 112 in an upwards-and-to-the-right direction. In other embodiments, for example, the micromovement may be a “finger-roll” and the user may position the finger 10 on the touch-sensitive display 112 in proximity to the virtual joystick 630 and may subsequently roll a tip of the finger 10 along an axis of the finger 10 in contact with the touch-sensitive display 112 in an upwards-and-to-the-right direction. In examples, the virtual joystick module 200 may receive the touch input or the sequence of touch inputs associated with the micromovement and may process the touch input(s) to generate touch input parameters 240 to the UI controller 134 for effecting a movement of the cursor 632 on the display.

In examples, the UI controller 134 may also communicate with an optional haptic unit 116 to generate a haptic feedback 150 for communicating to the user, for example, for allowing the user to understand how the user's touch is being interpreted as by the virtual joystick. In examples, the haptic feedback 150 may be generated when the cursor movement is initiated and may be consistent with a speed of the cursor movement, for example, the haptic feedback 150 may generate discrete vibrations or “jolts” as the cursor moves a pre-defined distance across the display, similar to cursor control using left/right/up/down arrow keys on a keyboard, or may change in frequency as the cursor speed increases or slows down, or the haptic feedback 150 may indicate when the trajectory of the cursor is misaligned with the target, among other possibilities.

FIG. 7 is a front view of an example embodiment of the electronic device 100, which is a smartphone in this example. Although FIG. 7 is illustrated in the context of a smartphone as the electronic device 100, this is not intended to be limiting. It should be understood that the description of FIG. 7 may be adapted for other embodiments of the electronic device 100, such as a tablet, laptop, smartwatch, etc. Similarly, although FIG. 7 is illustrated and discussed in the context of a finger 10 in contact with the touch-sensitive display 112 as the touch input 140, this is not intended to be limiting (e.g., other types of touch input facilitators, such as a stylus, may be used where similar rolling, rocking, and/or pivoting, etc. motions of the touch input facilitator, or any combination thereof, would cause detectable changes in the touch input 140).

For exemplary purposes, the UI of the electronic device 100 in FIG. 7 is configured to include a control region 710, including a spacebar control 715 for voice input 735 rendered on the touch-sensitive display 112, and a main region 620 displaying a text editing application, however it should be understood that other UI configurations may be used. In some devices, the space bar control 715 is allocated for voice input, for example, a user may engage the space bar control 715 (e.g., by pressing and holding the space bar control 715, among other interactions) to activate voice input on the electronic device 100. In some embodiments, for example, once voice input is enabled, the microphone 114 may capture a speaker's spoken language (e.g., dictation) as a speech signal 160 representative of the speaker's spoken language or utterance, for example, for transcribing by a natural language processor (NLP) into text for display in the text editing application. Although the space bar control 715 is described in this example with respect to voice input activation, it is understood that other controls of the UI may be used in conjunction with voice activation and is not intended to be limiting.

In the example of FIG. 7, a cursor 732 is rendered in the text editing application of the main region 720. A finger 10 (or thumb) of a user's hand may interact with the cursor 732 using the spacebar control 715 (or another control), for example, the spacebar control 715 may double as a virtual joystick 730 in the UI of the electronic device 100 when voice input has been activated. In examples, a user may position the finger 10 on the touch-sensitive display 112 in proximity to the spacebar control 715 for activating voice input, and simultaneously, for also activating the virtual joystick 730. In examples, a touch input or a sequence of touch inputs may be detected by the touch-sensitive display 112 in the control region 710, for example, the user may engage in one or more micromovements on the touch-sensitive display 112 to cause the cursor 732 to move on the display. For example, while voice input is actively capturing and transcribing a user's spoken language into the text editing application, a user may desire to edit the transcribed text. In examples, the user may pause the dictation and may engage the virtual joystick 730 to cause the cursor 732 to move to a target location 734 along a trajectory 736. In examples, the user may then resume dictation for text entry at the new cursor position in the text editing application. In this regard, voice input may be simultaneously coupled with text editing using examples of the present disclosure.

In some embodiments, for example, the UI controller 134 may also communicate with an optional haptic unit 116 to generate a haptic feedback 150 associated with the user interactions, for example, as described with respect to FIG. 6.

FIGS. 8A-8D are a front view of an example embodiment of the electronic device 100, which is a smartphone in this example. Although FIG. 8A-8D are illustrated in the context of a smartphone as the electronic device 100, this is not intended to be limiting. It should be understood that the description of FIGS. 8A-8D may be adapted for other embodiments of the electronic device 100, such as a tablet, laptop, smartwatch, etc. Similarly, although FIGS. 8A-8D are illustrated and discussed in the context of a finger 10 in contact with the touch-sensitive display 112 as the touch input 140, this is not intended to be limiting (e.g., other types of touch input facilitators, such as a stylus, may be used where similar rolling, rocking, and/or pivoting, etc. motions of the touch input facilitator, or any combination thereof, would cause detectable changes in the touch input 140).

For exemplary purposes, the UI of the electronic device 100 in FIGS. 8A-8D is configured to include a virtual joystick 830 rendered on the touch-sensitive display 112. In the example of FIG. 8B, a touch input may be detected by the touch-sensitive display 112 in proximity to the virtual joystick 830 to activate a virtual object on the UI such as a radial or marking menu 832, among other virtual objects or menus, causing the menu 832 to be rendered on the display. In the examples of FIG. 8C and FIG. 8D, a finger 10 (or thumb) of a user's hand may interact with the menu 832 using the virtual joystick 830, for example, by engaging in one or more micromovements on the touch-sensitive display 112. In examples, a touch input or a sequence of touch inputs may be detected by the touch-sensitive display 112 in proximity to the virtual joystick 830 to cause a menu item 834 of the menu 832 to be highlighted for selection on the display.

In some embodiments, for example, the micromovement may be a pivot micromovement, or another micromovement may be performed. For example, a user desiring to select a menu item 834 may pivot the finger 10 to apply a shear force to the touch-sensitive display 112 in a direction of the desired menu item 834. In examples, the virtual joystick module 200 may receive the touch input or the sequence of touch inputs associated with the micromovement and may process the touch input(s) to generate touch input parameters 240 to the UI controller 134 for effecting a selection of a desired menu item 834 on the display.

In some embodiments, for example, the UI controller 134 may also communicate with an optional haptic unit 116 to generate a haptic feedback 150 associated with the user interactions.

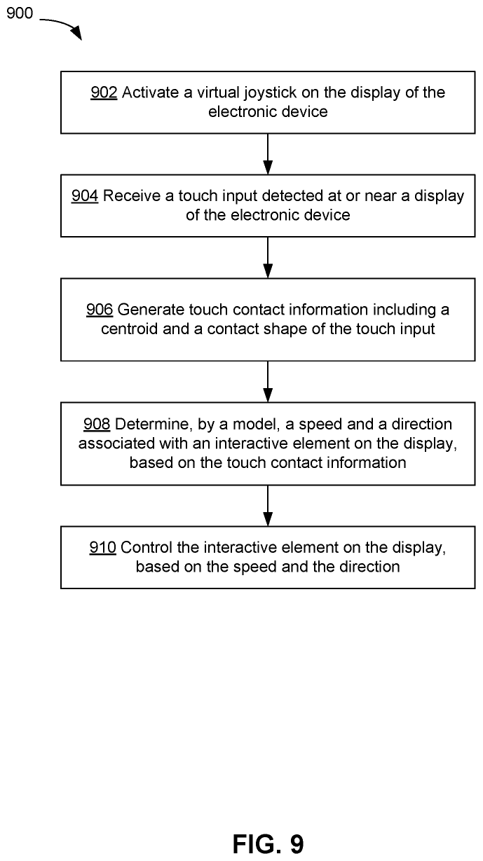

FIG. 9 is a flowchart illustrating an example method 900 for enabling touchscreen device interactions using a virtual joystick, in accordance with examples of the present disclosure. The method 900 may be performed by the electronic device 100. For example, the processing unit 102 may execute computer readable instructions (which may be stored in the memory 108) to cause the electronic device 100 to perform the method 900.

Method 900 begins with step 902, in which a virtual joystick is activated on the touch-sensitive display 112. In examples, a UI controller 134 may configured to control the interactive element in response to a user interaction with the virtual joystick.

At step 904, a touch input 140 detected at or near the touch-sensitive display 112 may be received. In examples, the touch input 140 may correspond to contact with the touch-sensitive display 112, for example, by a touch input facilitator such as a finger 10 of a user in contact with the touch-sensitive display 112, or by another object such as a stylus or digital pen in contact with the touch-sensitive display 112, among other objects or devices capable of capacitive or conductive contact with a touch-sensitive display 112. In other examples the touch input 140 may correspond to a placement of the finger 10 of the user or another object in close proximity to the touch-sensitive display 112, such that a raw capacitive signal is generated at the touch-sensitive display 112 in response to the placement.

At step 906, touch contact information 220 including a centroid and a contact shape of the touch input 140 may be generated, based on the touch input 140. In examples, the centroid and the contact shape of the touch input 140 may be representative of the user's finger 10 in contact with the touch-sensitive display 112, or representative of a stylus tip, among other possibilities.

At step 908, a speed and a direction associated with an interactive element on the display, may be determined, by a model, based on the touch contact information.

At step 910, the interactive element may be controlled on the display, based on the speed and the direction.

Examples of the present disclosure have been described in the context of user interactions using a virtual joystick on a touch screen enabled device, including, for example, a smartphone, a tablet device, a laptop device, a desktop device, a wearable device (e.g., smartwatch), a gaming console, an interactive kiosk device, or an Internet of Things (IoT) device, among other possibilities. In an embodiment, for example, interactions using a virtual joystick on a touchscreen device may enable the conversion of a small interaction space (such as on a smart watch, or other touchscreen devices having limited touchscreen interaction space) into a remote controller for controlling a smart TV or advancing presentation slides, among other examples. Although examples have been described in the context of interacting with a virtual joystick on a touch screen enabled device, it should be understood that the present disclosure is not limited to interactions on a portable or hand-held touch screen enabled device. For example, the touch input may also be representative of interactions with a vehicle-based device (e.g., an infotainment system, an interactive dashboard device or a touch-enabled steering wheel device), among others.

Various embodiments of the present disclosure having been thus described in detail by way of example, it will be apparent to those skilled in the art that variations and modifications may be made without departing from the disclosure. The disclosure includes all such variations and modifications as fall within the scope of the appended claims.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration in-formation, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method at an electronic device, the method comprising:
receiving a touch input detected at or near a display of the electronic device;
generating touch contact information including a centroid and a contact shape of the touch input;
determining, by a model, a speed and a direction associated with an interactive element on the display, based on the touch contact information; and
controlling the interactive element on the display, based on the speed and the direction.

2. The method of claim 1, wherein the touch input corresponds to contact with the display.

3. The method of claim 1, wherein the touch input corresponds to input by a finger of a user in contact with the display.

4. The method of claim 1, further comprising:
prior to receiving the touch input:
activating a virtual joystick on the display of the electronic device, wherein a user interface (UI) controller of the electronic device is configured to control the interactive element in response to a user interaction with the virtual joystick.

5. The method of claim 4, wherein the user interaction with the virtual joystick corresponds to a micromovement of the user's finger in contact with the display, the micromovement comprising at least one of:
a rolling movement;
a rocking movement; or
a pivoting movement.

6. The method of claim 1, wherein generating the touch contact information comprises:
receiving a raw capacitive signal associated with the touch input;
generating a high-resolution contact image based on the raw capacitive signal; and
determining the contact shape and the centroid based on the high-resolution contact image.

7. The method of claim 1, wherein the touch input is a first touch input corresponding to an anchor position on the display, the method further comprising:
receiving a sequence of further touch inputs;
generating further touch contact information including at least one further contact shape or at least one further centroid, based on the sequence of further touch inputs;
comparing at least one of the centroid of the first touch input with the at least one further centroid or the contact shape of the first touch input with the at least one further contact shape, to determine a displacement from the anchor position, based on the comparison;
determining, by the model, an updated speed and an updated direction associated with the interactive element on the display, based on the displacement; and
controlling the interactive element on the display, based on the updated speed and the updated direction.

8. The method of claim 1, wherein controlling the interactive element on the display comprises:
providing the speed and the direction to a user interface (UI) controller of the electronic device for controlling the interactive element on the display.

9. The method of claim 7, wherein the interactive element is a cursor.

10. The method of claim 7, wherein the interactive element is a menu.

11. The method of claim 1, wherein the display is a capacitive touch-sensitive display.

12. A touch-enabled device, comprising:
a touch-sensitive display;
a processor coupled to the touch-sensitive display; and
a non-transitory memory coupled to the processor, the non-transitory memory storing machine-executable instructions which, when executed by the processor, cause the touch-enabled device to:
receive a touch input detected at or near the display;
generate touch contact information including a centroid and a contact shape of the touch input;
determine, by a model, a speed and a direction associated with an interactive element on the display, based on the touch contact information; and
control the interactive element on the display, based on the speed and the direction.

13. The device of claim 12, wherein the touch input corresponds to contact with the display.

14. The device of claim 12, wherein the touch input corresponds to input by a finger of a user in contact with the display.

15. The device of claim 12, wherein the instructions, when executed by the processor, cause the touch-enabled device to:
prior to receiving the touch input:
activate a virtual joystick on the display, wherein a user interface (UI) controller of the touch-enabled device is configured to control the interactive element in response to a user interaction with the virtual joystick.

16. The device of claim 15, wherein the user interaction with the virtual joystick corresponds to a micromovement of the user's finger in contact with the display, the micromovement comprising at least one of:
a rolling movement;
a rocking movement; or
a pivoting movement.

17. The device of claim 12, wherein the instructions, when executed by the processor to generate the touch contact information, cause the touch-enabled device to:
receive a raw capacitive signal associated with the touch input;
generate a high-resolution contact image based on the raw capacitive signal; and
determine the contact shape and the centroid based on the high-resolution contact image.

18. The device of claim 12, wherein the touch input is a first touch input corresponding to an anchor position on the display, wherein the instructions, when executed by the processor, further cause the touch-enabled device to:
receive a sequence of further touch inputs;
generate further touch contact information including at least one further contact shape or at least one further centroid, based on the further touch inputs;
compare at least one of the centroid of the first touch input with the at least one further centroid or the contact shape of the first touch input with the at least one further contact shape, to determine a displacement from the anchor position, based on the comparison
determine, by the model, an updated speed and an updated direction associated with the interactive element on the display, based on the displacement; and
control the interactive element on the display, based on the updated speed and the updated direction.

19. The device of claim 12, wherein the instructions, when executed by the processor to control the interactive element on the display, further cause the touch-enabled device to:
provide the speed and the direction to a user interface (UI) controller of the touch-enabled device for controlling the interactive element on the display.

20. A non-transitory computer-readable medium having machine-executable instructions stored thereon, the machine-executable instructions, when executed by a processor of a device having a touch-sensitive display, cause the device to:
receive a touch input detected at or near the display;
generate touch contact information including a centroid and a contact shape of the touch input;
determine, by a model, a speed and a direction associated with an interactive element on the display, based on the touch contact information; and
control the interactive element on the display, based on the speed and the direction.
